(19) United States
(12) Patent Application Publication
(10) Pub. No.: US 2018/0316411 A1
(43) Pub. Date: Nov. 1, 2018

(54) RELAY APPARATUS AND ITS RELAY METHOD

(71) Applicant: SoftBank Corp., Tokyo (JP)

(72) Inventors: Takayuki YOSHIMURA, Tokyo (JP); Masahiko NANRI, Tokyo (JP); Masanori NOMACHI, Tokyo (JP); Takanori TAKII, Tokyo (JP); Jumpei TAKAGI, Tokyo (JP)

(21) Appl. No.: 15/506,722

(22) PCT Filed: Dec. 14, 2016
(86) PCT No.: PCT/JP2016/087308

§ 371 Date: Feb. 24, 2017

(30) Foreign Application Priority Data
Oct. 20, 2016 (JP) 2016-206416

(51) Int. Cl. H04B 7/155

(52) U.S. Cl. CPC H04B 7/1555; H04W 84/045; H04B 7/15535; H04B 7/15507

(57) ABSTRACT

A relay apparatus is provided which is capable of properly executing beamforming for radio communication from the relay apparatus to a donor base station, while inhibiting occurrence of beam interference in its surrounding area as much as possible. A relay apparatus 20 includes: an amplitude and phase measurement unit 25 that measures an amplitude and phase of radio communication from a donor base station 30 to the relay apparatus 20; a beam adjuster 27 that performs beamforming by adjusting a combination of a plurality of antennas; and a base station judgment unit 29 that judges base stations; wherein the adjustment for the beamforming is made so that a relatively strong beam is directed towards the donor base station 30 and a relatively weak beam is directed towards base stations other than the donor base station 30.

### TECHNICAL FIELD

The present invention relates to a relay apparatus and its relay method for relaying communication between a terminal device and a donor base station.

### BACKGROUND ART

Communication standards concerning mobile communications include the third generation mobile phone (3G) standard and the LTE (Long Term Evolution) standard. Various available frequency bands are set for each communication standard and specifications for each frequency band are defined precisely.

Conventionally, a relay apparatus is used to improve coverage when a terminal device is used indoors. Any one of a plurality of frequency bandwidths defined for the communication standards is selected for access radio, which is radio communication between the relay apparatus and the terminal device, and for backhaul radio, which is radio communication between the relay apparatus and a donor base station.

Various techniques that deal with such a relay apparatus are proposed. For example, PTL 1 discloses a technique that performs beamforming of a signal relating to the backhaul radio by using a plurality of antennas provided on a relay apparatus.

### CITATION LIST

### Patent Literature

PTL 1: Japanese Unexamined Patent Application Publication (Translation of PCT Application) No. 2015-520996 ([claim 24, etc.)

### SUMMARY OF THE INVENTION

### Problems to be Solved by the Invention

However, when the beamforming is performed by using the plurality of antennas, not only a beam with a strong amplitude and phase only in a specific direction is formed, but also small beams with a certain degree of amplitudes and phases are formed in directions other than the above-mentioned specific direction. If another base station or its own femto cell base station is located in any one of the small beams formed in this surrounding area, interference will occur there and cause degradation of communication quality at these base stations. Even if the status of communication with the donor base station is good, anything that would adversely affect the radio communication in the surrounding area should be avoided.

The present invention was devised in light of the above-described circumstances and it is an object of the invention to provide a relay apparatus and its relay method capable of properly executing beamforming for radio communication from the relay apparatus to a donor base station, while inhibiting occurrence of beam interference in the surrounding area.

### Solution to Problem

In order to achieve the above-described object, a relay apparatus provided according to an embodiment of the present invention is a relay apparatus for relaying communication between a terminal device and a donor base station, wherein the relay apparatus includes: an amplitude and phase measurement unit that measures an amplitude and phase of radio communication from surrounding base stations including the donor base station to the relay apparatus; a beam adjuster that makes adjustment for beamforming by adjusting a combination of a plurality of antennas used at the relay apparatus on the basis of the measured amplitude and phase; and a base station judgment unit that judges the surrounding base stations, wherein the adjustment for the beamforming is made so that a relatively strong beam is directed towards the donor base station and a relatively weak beam is directed towards the base stations other than the donor base station.

According to this aspect, the relay apparatus adjusts the beamforming so that the relatively strong beam is directed towards the donor base station and the relatively weak beam is directed towards the base stations other than the donor base station. Therefore, the adjustment for the beamforming for the radio communication (uplink) from the relay apparatus to the donor base station can be made properly, while inhibiting occurrence of beam interference at the surrounding base stations other than the donor base station as much as possible.

When any one of the surrounding base stations fulfills a specified condition, the adjustment for the beamforming may be made so that selecting the base station, which fulfills the specified condition, as the donor base station is prohibited and a beam of relatively small field intensity is directed towards the base station which fulfills the specified condition. The “specified condition” herein used includes that the relevant base station is a target of access class regulation, congestion regulation, etc.

A relay method for a relay apparatus according to an embodiment of the present invention includes: a step of measuring an amplitude and phase of radio communication from surrounding base stations including a donor base station to the relay apparatus; a beam adjustment step of making adjustment for beamforming for radio communication from the relay apparatus to the donor base station by adjusting a combination of a plurality of antennas used at the relay apparatus on the basis of the measured amplitude and phase; and a step of judging the surrounding base stations, wherein the adjustment for the beamforming is made so that a relatively strong beam is directed towards the donor base station and a relatively weak beam is directed towards the base stations other than the donor base station.

### Advantageous Effects of the Invention

A relay apparatus and its relay method capable of properly executing beamforming for radio communication from the relay apparatus to a donor base station, while inhibiting occurrence of beam interference in surrounding base stations can be provided according to the present invention.

### BRIEF DESCRIPTION OF DRAWINGS

FIG. 1 is an explanatory diagram illustrating a radio network configuration of a mobile communication system;

FIG. 2 is a block diagram of a relay apparatus according to a first embodiment;

FIG. 3 is a sequence diagram of normal operation of the relay apparatus;

FIG. 4 is a flowchart of a relay method for the relay apparatus according to the first embodiment;

FIG. 5 is an explanatory diagram of malfunctions when directivity is assigned to beam intensity distribution;

FIG. 6 is an explanatory diagram in a state where the directivity is relatively good in the beam intensity distribution;

FIG. 7 is a flowchart of a relay method for the relay apparatus according to the second embodiment;

FIG. 8 is an explanatory diagram of a K-element linear antenna;

FIG. 9A is an illustration of a directivity pattern of isotropic antenna elements having 6-elements half-wavelength interval; and

FIG. 9B is an illustration of a directivity pattern of isotropic antenna elements having 6-elements one-wavelength interval.

### DESCRIPTION OF EMBODIMENTS

Preferred embodiments of the present invention will be explained below with reference to the attached drawings. Incidentally, elements to which the same reference numeral is assigned in each drawing have the same or similar configurations.

### First Embodiment

(Radio Network Configuration)

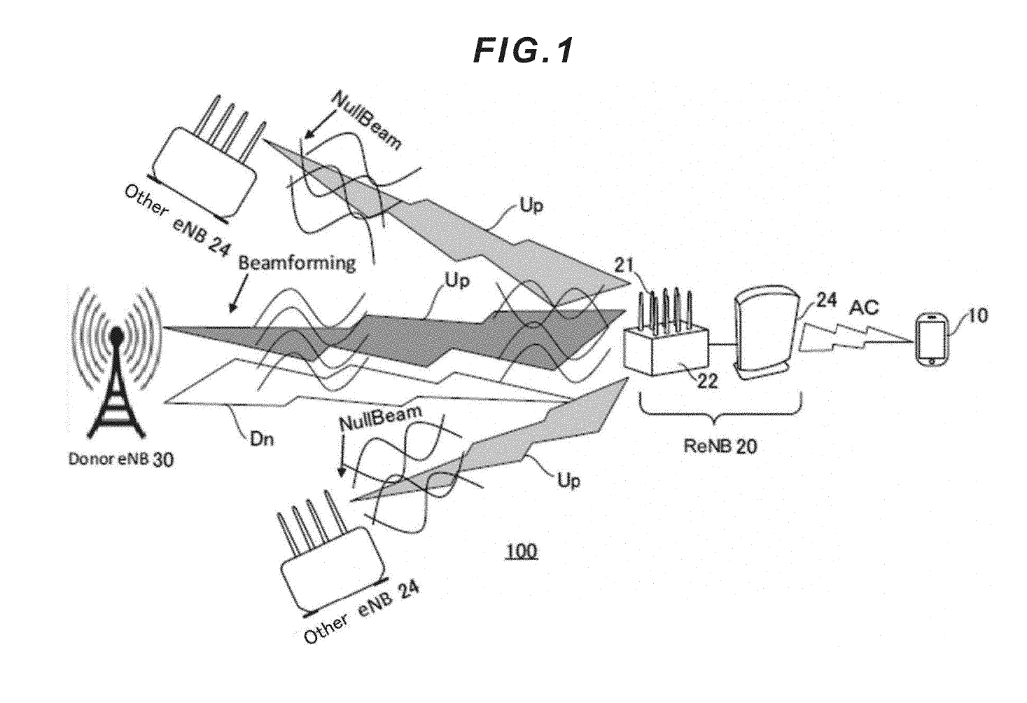

Firstly, a radio network configuration of a mobile communication system to which a relay apparatus according to a first embodiment is applied will be explained. FIG. 1 is an explanatory diagram illustrating the radio network configuration of the mobile communication system. Referring to FIG. 1, a radio network of a mobile communication system 100 includes a terminal device 10, a relay apparatus 20, and a donor base station 30.

The terminal device 10 is a mobile communication terminal such as a smartphone or a cell phone. FIG. 1 illustrates a state in which the terminal device 10 exists in an available service range of the relay apparatus 20.

The entire relay apparatus 20 is also called a ReNB (Relay Node B) which means a node for relaying communication between the donor base station 30 and the terminal device 10. Specifically speaking, the relay apparatus 20 includes: a relay node 22 that executes radio communication relating to backhaul radio with the donor base station 30; and an access node 24 that executes radio communication relating to access radio with the terminal device 10. Referring to FIG. 1, the relay node 22 and the access node 24 are configured as independent separate devices, but they may be configured as an integrated device in which the functions of both nodes are consolidated. The relay node 22 and the access node 24 handle packet data as radio signals. Packet communication services (such as voice packet communication services and multimedia services) are provided to the terminal device 10 by enabling transmission and reception of the packet data.

The relay node 22 constitutes one node in the radio network and is a node that establishes backhaul radio communication with the donor base station 30. The relay node 22 is also called customer premises equipment CPE (Customer Premises Equipment). The relay node 22 can establish communication with the donor base station 30 by selecting any one of a plurality of frequency bandwidths which are defined as selectable according to the communications standard.

The relay node 22 includes an antenna group 21. The antenna group 21 is an aggregate of a plurality of antenna elements. The relay node 22 is configured to control an amplitude and phase of excitations of each antenna element individually and independently. Directivity regarding a radio signal received by the antenna group 21 can be controlled by a combination of antenna elements used from among the plurality of antenna elements. Accordingly, a signal gain regarding the radio signal from a certain direction can be increased by appropriately selecting the antenna elements to be used.

The access node 24 constitutes one node in the radio network and is a node that establishes access radio communication with the terminal device 10. The access node 24 is also called an HeNB (Home eNode B) or Femtocell (Femto Cell) base station according to the LTE standard. The cell size formed by the access node 24 is of a smaller scale than that of the donor base station 30 and constructs a communication area with a radius ranging from several meters to tens of meters.

It is known that when the same frequency is used, a radio signal passes through the same propagation path for the radio communication (downlink Dn) from the donor base station to the relay node 22 and the radio communication (uplink Up) from the relay node 22 to the donor base station. In other words, it is known that when a signal of the same frequency bandwidth is used for the downlink Dn and the uplink Up and if the amplitude and phase of the uplink UP at the relay node 22 are made to be the same amplitude as that of the downlink Dn and an opposite phase of the phase of the downlink Dn, directivity of a radio wave of the downlink Dn and directivity of a radio wave of the uplink Up become similar to each other. Specifically speaking, under the condition that the frequency bandwidth used for the radio communication, the position of the donor base station 30, and the position of the relay node 22 are the same, radio communication of the best combined reception quality can be provided at the donor base station 30 when the amplitude and phase of the uplink Up are made to be the same amplitude as that of the downlink Dn and an opposite phase of the phase of the downlink Dn.

Consequently, if the amplitude and phase of the downlink radio communication are measured and the same amplitude as that of the downlink Dn and an opposite phase of the phase of the downlink Dn are used for the uplink Up, the shape of beam of the radio communication to the donor base station 30 can be adjusted to make the beam focused with respect to the uplink Up and the beam can be transmitted as a strong radio wave to the donor base station 30, that is, preferred beamforming can be executed.

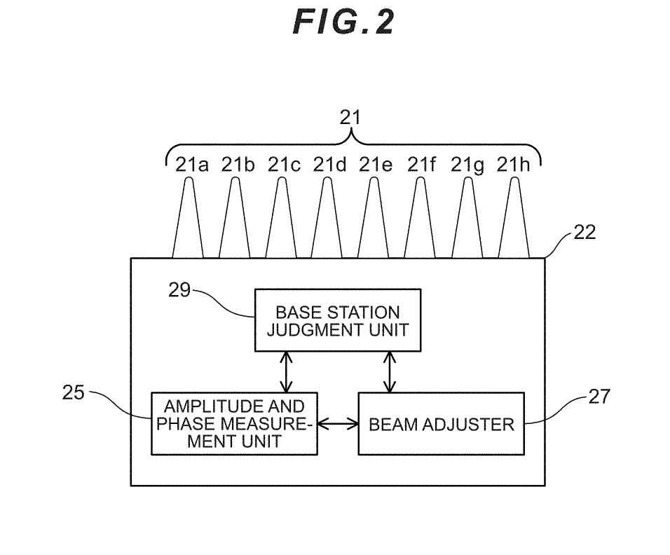

FIG. 2 is a block diagram of the relay node 22 according to this embodiment. Referring to FIG. 2, the relay node 22 includes: an amplitude and phase measurement unit 25 that measures the amplitude and phase of the radio communication; a beam adjuster 27 that makes adjustments for the beamforming with respect to the donor base station 30; and a base station judgment unit 29 that judges surrounding base stations including the donor base station 30.

The amplitude and phase measurement unit 25 is an adaptive array for measuring the amplitude and phase of, for example, a radio signal of the downlink Dn.

The beam adjuster 27 adjusts the amplitudes and phases from the plurality of antenna elements so that such amplitude and phase become the same amplitude as that of the downlink Dn and an opposite phase of the phase of the downlink Dn measured by the amplitude and phase measurement unit 25, thereby making adjustments for the beamforming to adjust the shape of beams of the radio communication to the donor base station 30 with respect to the uplink Up, making the beam focused, and transmits them as a strong radio wave to the donor base station 30. The antenna group 21 and the beam adjuster 27 may be designed as, for example, an adaptive array system that performs adaptive control of the directivity characteristics of the antenna group 21. The details will be explained later.

The base station judgment unit 29 judges surrounding base stations including the donor base station. For example, the base station judgment unit 29 acquires specified identification information (such as EARFCN or PCI) from a surrounding base station capable of communication and judges whether the relevant base station is the donor base station at that point in time or another base station. Moreover, the base station judgment unit 29 may judge the surrounding base stations on the basis of information which the relay apparatus 22 has already obtained. Furthermore, the base station judgment unit 29 may judge the surrounding base stations by inquiring at a core network.

The donor base station 30 is configured to establish the radio communication with the relay node 22 and also directly establish the access radio communication with the terminal device 10. The donor base station 30 constructs a communication area with a radius ranging from hundreds of meters to tens of kilometers.

(Operation of Radio Network)

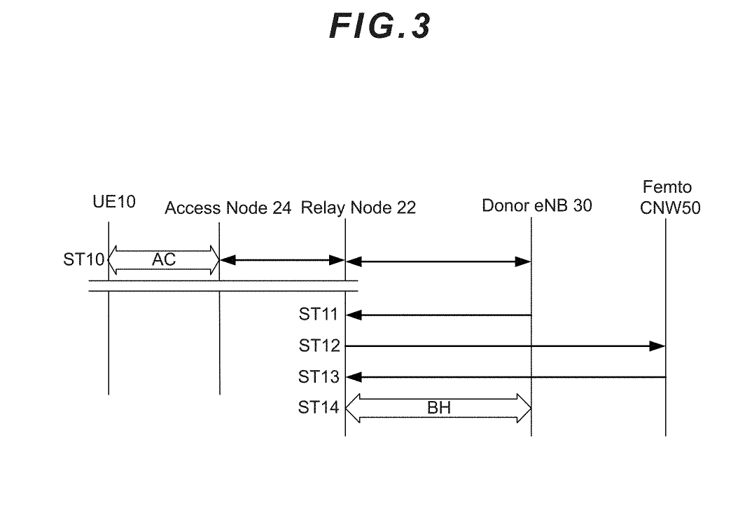

FIG. 3 is a sequence diagram of normal operation of the relay apparatus. Referring to FIG. 3, when the terminal device 10 which performs only Wifi communication with the access node 24 of the relay apparatus 20 exists in the relevant area, a Wifi session is generated and access communication (AC) is executed between the terminal device 10 and the access node 24 of the relay apparatus 20 (ST10).

When the relay apparatus 20 starts connecting with the donor base station 30, the relay node 22 acquires connection destination identification information from the donor base station 30 (ST11).

The relay node 22 connects with the donor base station 30 on the basis of the connection destination identification information (ST12). When this happens, the relay node 22 transmits a measure report to a femto core network (Femto CNW) 50 that performs failure management, quality management, and activation/stop control management of the relay apparatus 20.

On the other hand, the femto core network 50 judges communication quality, communication traffic volume, and so on with respect to communication with the relay node 22 on the basis of the measure report from the relay node 22 (ST13). Then, the connection is established between the relay node 22 and the donor base station 30, thereby executing backhaul communication (BH) (ST14).

The femto core network 50 of the donor base station 30 continues to judge the communication quality, communication traffic volume, and so on with respect to the communication between the relay node 22 and the donor base station 30 on the basis of the measure report from the relay node 22.

According to this embodiment, the amplitude and the phase from the antenna elements which are used by the relay node 22 for the uplink Up radio communication with the donor base station 30 are properly selected, high combined reception quality is maintained in the radio communication relating to the backhaul radio, and communication with high communication quality and at preferred communication speeds can be ensured.

(Principles of Beamforming by Array Antennas)

In the first embodiment, an array antenna in which a plurality of antenna elements are arrayed and which is designed to control the amplitude and phase of excitations of each antenna element independently is adopted as the antenna 21. Furthermore, for example, an adaptive array system which performs adaptive control of directivity characteristics of the array antenna is adopted as the beam adjuster 27.

Now, principles of beamforming by the array antenna will be explained by referring to literature on “Foundations of Array Antennas” (written by Nobuyoshi Kikuma, Department of Computer Science and Engineering, Graduate School of Engineering, Nagoya Institute of Technology) about the principles of the adaptive array system.

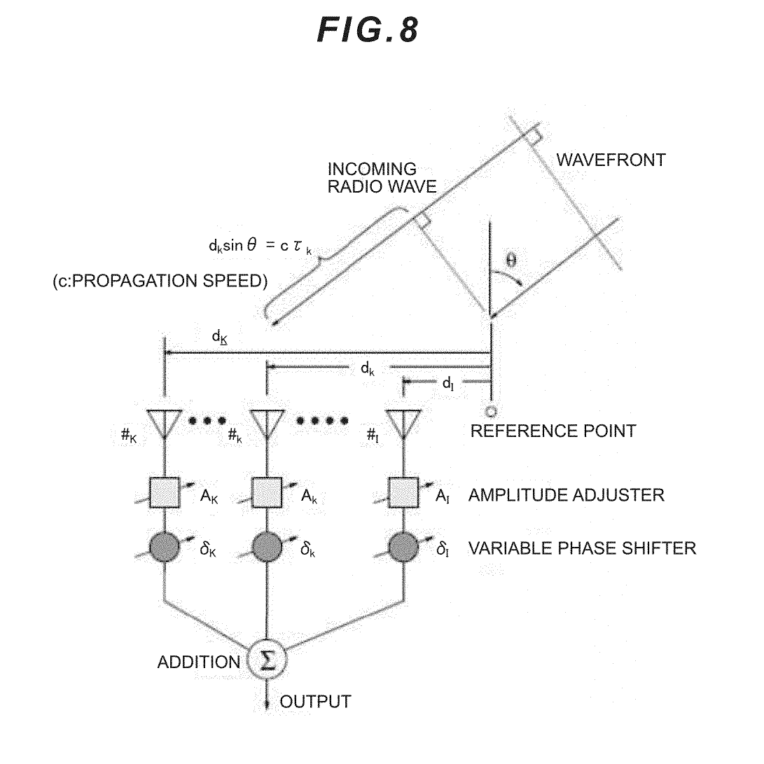

Various arrays such as a linear array, a flat plane array, or a curved plane array are possible as a method for arraying the antenna elements to configure the array antenna; however, in the following explanation, a linear array composed of K pieces of identical antenna elements as illustrated in FIG. 8 will be considered in order to understand basic principles.

Let us assume that one radio wave has arrived from a direction of angle θ as measured from a broadside. When Eₒ represents an incoming signal at a reference point on a base line, g(θ) represents a directivity function of the antenna elements, and the incoming signal has a narrow band relative to the array, a voltage induced at a k-th antenna element can be calculated according to Expression (1) below.

$$\begin{matrix}[ Math . 1 ] & \\ {E}_{k} = {E}_{0} g ( θ ) exp ( - j \frac{2 π}{λ} {d}_{k} sin θ ) \\ ( k = 1 , 2 , … , K ) & ( 1 ) \\ [ Math . 2 ] & \\ {E}_{sum} = {E}_{0 g} ( θ ) D ( θ ) & ( 2 ) \\ [ Math . 3 ] & \\ D ( θ ) = {\sum }_{k = 1}^{K} {A}_{k} exp \{ j ( - \frac{2 π}{λ} {d}_{k} sin θ + {δ}_{k} ) \} & ( 3 )\end{matrix}$$

In the above expression, Aₖ and δₖ are weight and phase-shift quantity, which are multiplied by the k-th element, respectively. Moreover, D(θ) represents an array factor. Referring to Expression (2), directivity of the entire array is expressed by a product obtained by multiplying the element directivity g(θ) by the array factor D(θ). This is called the law of pattern multiplication. Therefore, when all the antenna elements are the same and are positioned in the same direction, the directivity of the entire array can be adjusted effectively by controlling the array factor.

For example, when an attempt is made to maximize the size of the array factor in a certain angle θₒ, generally the phase-shift quantity δₖ is selected as follows.

$$\begin{matrix}[ Math . 4 ] & \\ {δ}_{k} = \frac{2 π}{λ} {d}_{k} sin {θ}_{0} & ( 4 )\end{matrix}$$

Specifically speaking, it is designed so that phases of outputs from a phase shifter regarding a desired signal become identical to each other with respect to the respective elements. The phases of outputs from the respective elements do not become identical to each other in directions other than the above-mentioned direction and are offset from each other to some degree. If the array antenna is used in the above-described manner, gain for the desired signal increases. However, when an element interval is large, the phases become identical to each other and are added even with the angle θ_{gm} which satisfies Expression (5) below and, therefore, a large array response value is generated.

$$\begin{matrix}[ Math . 5 ] & \\ - \frac{2 π}{λ} {d}_{k} sin {θ}_{gm} + {δ}_{k} = 2 m π ( m = \pm 1 , \pm 2 , … ) & ( 5 )\end{matrix}$$

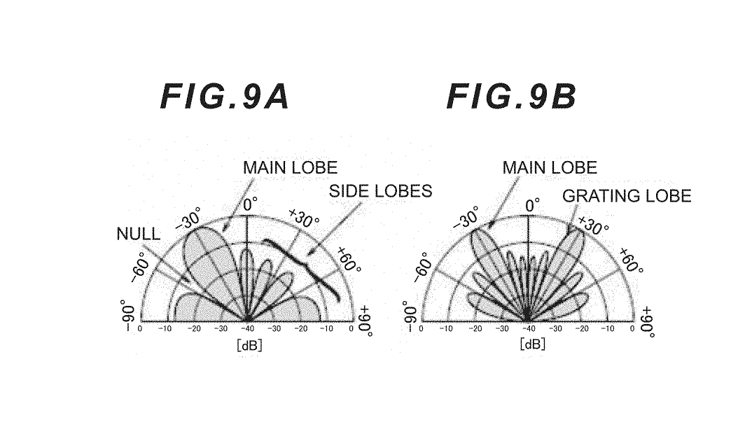

This is called a grating lobe (see FIG. 9) and a preventive measure is normally taken in a designing stage. The absolute value |Esum| in Expression (2) which is expressed as a function of the angle θ is called a directivity pattern and values around its maximum value are called a main lobe (main beam) (see FIG. 9). There are also many other locally maximum values, but they are called side lobes. Furthermore, a zero point between the lobes is called a null.

A direction of the null can be also called a direction towards which a null lobe is directed.

If an unnecessary wave source exists in the side lobe direction, a received voltage according to the wave source is induced. If a ratio between the unnecessary wave and the desired signal is larger than an inverse number of a ratio between the side lobe and the main lobe, the signal becomes inferior to the unnecessary wave even at the output end of the antenna system.

When the antenna elements are located at equal intervals, the array factor in Expression (3) takes a homogeneous polynomial form. Consequently, it is possible to select Aₖ appropriately by using a mathematical means and thereby generally reduce the side lobe or make a response value of the incoming direction become zero with respect to a specific strong unnecessary wave.

However, if that incoming direction is unknown or changes, it is necessary to feed back information obtained from whatever learning and create optimum characteristics. The system based on the above-described ideas is the adaptive array.

According to the theories of beamforming as described above, the main lobe is the strongest beam and it is desirable to adjust directivity of the beam so as to direct this main lobe towards the donor base station which is the target.

Under this circumstance, even when the adjustment is made to direct the main lobe towards the donor base station, if any one of the side lobes to which the above theories refer to is directed towards another surrounding base station, beam interference will occur at that base station. So, this first embodiment is characterized in that while making adjustment to direct the lobe towards the donor base station, consideration is given to direct a relatively weak beam, that is, a null lobe which means between lobes towards other surrounding base stations. In this first embodiment, even when the main lobe is directed towards the donor base station, if any one of the side lobes is directed towards another surrounding base station at the same time, the phase selection is changed. Then, a combination of antenna elements that will direct the null lobe towards the other surrounding base stations is selected. Accordingly, when the phase to direct the null lobe(s) to other surrounding base stations is prioritized, it is also allowed to select a phase to direct only the side lobe(s), not the main lobe, towards the donor base station.

(Principles of Relay Method According to this First Embodiment)

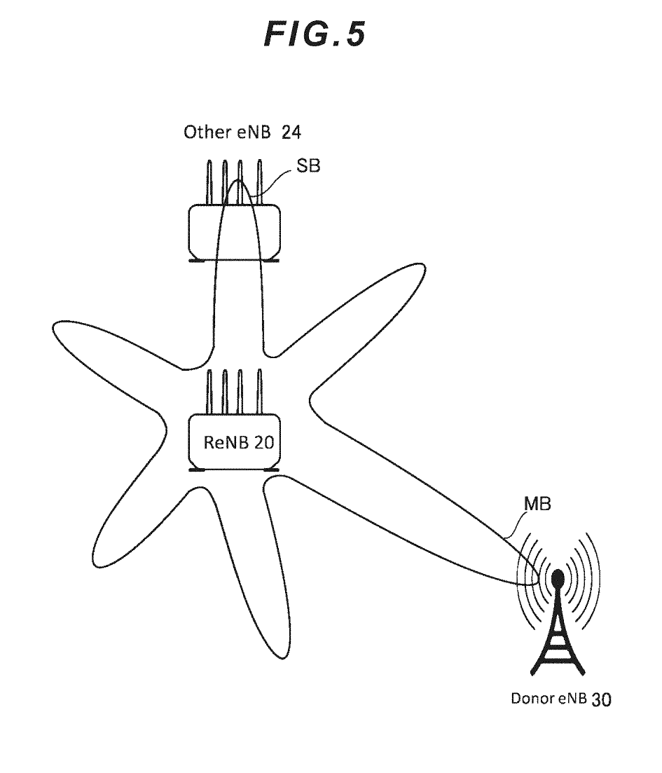

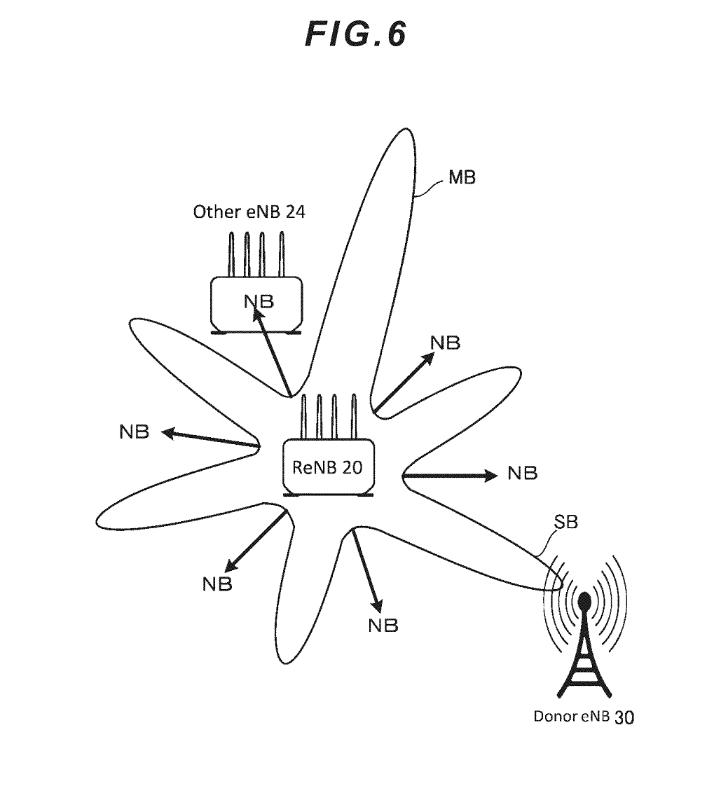

Next, principles of the relay method according to this first embodiment will be explained. FIG. 5 is an explanatory diagram of malfunctions when directivity is assigned to beam intensity distribution and FIG. 6 is an explanatory diagram in a state where the directivity is relatively good in the beam intensity distribution.

Regarding normal beamforming as illustrated in FIG. 5, a combination of a plurality of antenna elements is adjusted so as to direct the strongest beam (main lobe) MB, which is formed by assigning the directivity to beams from the antenna group 21, towards the donor base station 30. However, even when the relatively strong main beam MB is directed towards the donor base station, if any of side beams SB which are inevitably formed other than the main lobe is directed towards another base station (or the its own femto cell base station) 24 which exists around the relay node 22, interference of a radio signal will occur at that base station 24.

So, this first embodiment is designed so that when another base station 24 exists around the relay node 22, the main lobe MB does not necessarily have to be directed towards the donor base station 30 as long as a side lobe SB having a certain degree of intensity is directed towards the donor base station 30 as illustrated in FIG. 6; and instead, processing should be executed to adjust the plurality of antenna elements by prioritizing directing of a null beam NB (Null Beam) towards the other base station 24.

(Relay Method)

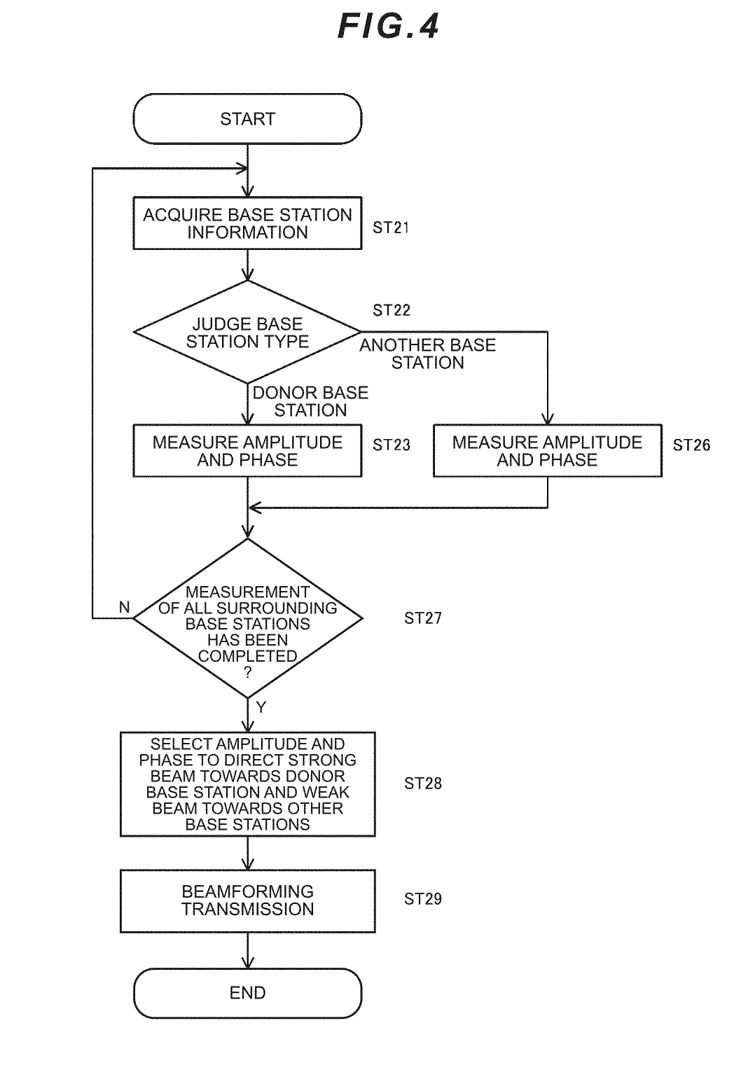

Next, a relay method for the relay apparatus according to the first embodiment will be explained with reference to FIG. 4. FIG. 4 is a flowchart of the relay method for the relay apparatus according to the first embodiment.

It is known, as described earlier, that the radio communication (downlink Dn) from the donor base station 30 to the relay node 22 and the radio communication (uplink Up) from the relay node 22 to the donor base station 30 are routed through the same propagation path.

In this first embodiment, the amplitude and phase of the downlink Dn radio communication are measured and the same amplitude as that of the downlink Dn and an opposite phase of the phase of the downlink Dn are used for the uplink Up, thereby performing radio communication of higher combined reception quality.

Under this circumstance, particularly this first embodiment is characterized in that when any of connection destinations is another base station, further adjustment is made for the beamforming so as to direct a relatively weak beam (null beam) NB towards the other base station.

Referring to FIG. 4, the relay node 22 acquires information about surrounding base stations including the donor base station 30 (ST21). Such information includes, for example, EARFCN and/or PCI. Next, the base station judgment unit 29 judges whether identification information represents the donor base station or another base station (ST22).

When the identification information represents the donor base station 30 (ST22: donor base station), the measurement of the amplitude and the phase by the amplitude and phase measurement unit 25 is started (ST23). The amplitude and phase measurement unit 25 measures and records the amplitude and phase of the downlink Dn from the donor base station 30 to the relay node 22.

On the other hand, when the identification information represents the other base station 24 (ST22: another base station), the amplitude and phase measurement unit 25 measures an amplitude and phase of the other base station 24 (ST26). The amplitude and phase measurement unit 25 measures and records the amplitude and phase of the downlink Dn from the other base station to the relay node 22.

The above-described amplitude and phase measurement is executed as long as a base station(s) which has not been measured exists in the surrounding area (ST27: N). When the amplitude and phase measurement of all the base stations existing in the surrounding area including the donor base station has been completed (ST27: Y), the processing proceeds to step ST28.

The beam adjuster 27 refers to the recorded amplitudes and phases of the donor base station 30 and all the other base stations and adjusts the amplitude and movement of the uplink Up by adjusting a combination of a plurality of antennas included in the antenna group 21 so that a relatively strong beam will be directed towards the donor base station 30 and a relatively weak beam will be directed towards the other base station(s) (ST28). For example, the beam adjuster 27 adjusts the uplink Up from the plurality of antenna elements so that either the main lobe MB or the side lobe SB will be directed towards the donor base station 30 and the null beam NB (or a relatively weak beam if there is no option) will be directed towards the other base station(s).

When the adjustment is completed, the beamforming is executed by ejecting an uplink Up radio wave with the set amplitude and phase so that either the main lobe MB or the side lobe SB is directed towards the donor base station 30 and the null beam NB (or a relatively weak beam when there is no option) towards the other base stations (ST29).

Regarding the relay apparatus 20 and its relay method according to the first embodiment explained above, when the identification information acquired from a base station which exists in the surrounding area of the relay node 22 and is capable of communication represents the donor base station 30, the amplitude and phase measurement unit 25 measures the amplitude and phase of the downlink Dn from the donor base station 30 to the relay apparatus 20. On the other hand, when the identification information represents another base station 24, the uplink Up is adjusted to direct the null beam NB towards that base station 24. Therefore, when the relay apparatus 20 and its relay method according to the first embodiment are employed, the adjustment is made to prevent strong beams from reaching the other base station(s) 24 and, therefore, the beamforming can be executed properly with respect to the donor base station 30 while preventing hindrance from interference in the surrounding area.

### Second Embodiment

The difference between the relay apparatus 20 according to a second embodiment and the first embodiment is that the base station judgment unit 29 also judges a specified condition in the second embodiment.

The configuration of the relay apparatus according to the second embodiment will be explained. The relay apparatus according to the second embodiment is configured in the same manner as that of the first embodiment as explained with reference to FIG. 2. However, unlike the first embodiment, the base station judgment unit 29 judges whether a specified condition is fulfilled or not.

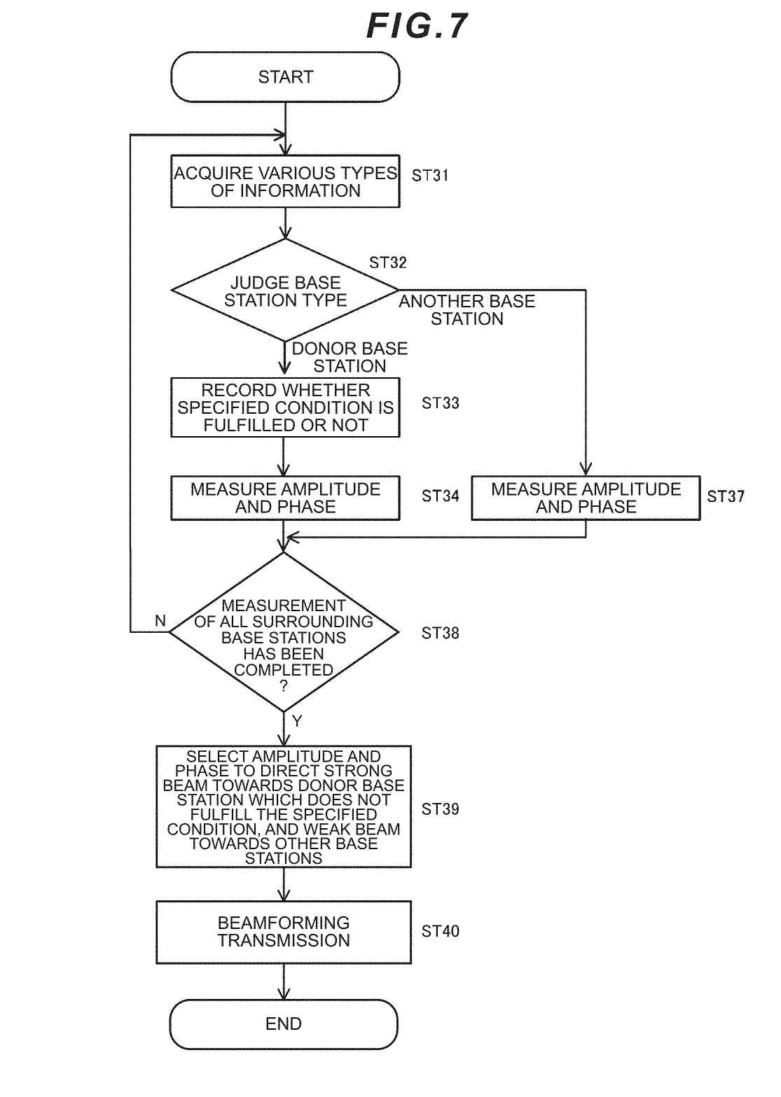

Next, a relay method for the relay apparatus according to the second embodiment will be explained. FIG. 7 is a flowchart of the relay method for the relay apparatus according to the second embodiment.

Referring to FIG. 7, the relay node 22 acquires various types of information from base stations existing in its surrounding area (ST31). Next, the base station judgment unit 29 judges whether the various types of information represent the donor base station or another base station (ST32).

When the various types of information represent another base station 24 (ST32: another base station), the processing proceeds to a step of ST37 and the amplitude and phase measurement unit 25 measures an amplitude and phase of radio communication with the other base station 24 (ST37).

When the various types of information represent the donor base station 30 (ST32: donor base station), the base station judgment unit 29 further judges whether a specified condition is fulfilled or not, on the basis of the various types of information (ST33). The specified condition includes, for example, that the relevant base station is a target of access class regulation or congestion regulation.

After recording whether the specified condition is fulfilled or not, the amplitude and phase measurement unit 25 measures an amplitude and phase of radio communication with the donor base station 30 (ST34).

The above-described amplitude and phase measurement is executed as long as a base station(s) which has not been measured exists in the surrounding area (ST38: N). When the amplitude and phase measurement of all the base stations existing in the surrounding area including the donor base station has been completed (ST38: Y), the processing proceeds to step ST39.

The beam adjuster 27 refers to the recorded amplitudes and phases of the donor base station 30 and all the other base stations and adjusts the amplitude and movement of the uplink Up by adjusting a combination of a plurality of antennas included in the antenna group 21 so that a relatively strong beam will be directed towards the donor base station 30, which does not fulfill the specified condition, and a relatively weak beam will be directed towards the donor base station 30, which fulfills the specified condition, and the other base station(s) (ST39). For example, the beam adjuster 27 adjusts the uplink Up from the plurality of antenna elements so that either the main lobe MB or the side lobe SB will be directed towards the donor base station 30, which does not fulfill the specified condition, and the null beam NB (or a relatively weak beam if there is no option) will be directed towards the donor base station 30, which fulfills the specified condition, or the other base station(s).

When the adjustment is completed, the beamforming is executed by ejecting an uplink Up radio wave with the set amplitude and phase so that either the main lobe MB or the side lobe SB is directed towards the donor base station 30, which does not fulfill the specified condition, and the null beam NB (or a relatively weak beam when there is no option) towards the donor base station 30, which fulfills the specified condition, or the other base station(s) (ST40).

Regarding the relay apparatus 20 and its relay method according to this second embodiment explained above, not only when a connection destination of the radio communication with the relay node 22 is another base station 24, but also when such connection destination is the donor base station 30, if the relevant donor base station 30 is under communication control such as the access class regulation or the congestion regulation, the uplink Up is adjusted to direct the null beam towards that donor base station 30. Therefore, when not only the other base station(s), but also the donor base station 30 is under communication control, the beamforming can be executed to prevent the relatively strong beam from being directed towards the donor base station 30.

[Variability]

The aforementioned embodiments have been described in detail in order to explain the invention in an easily comprehensible manner and are not intended to interpret the present invention in a limited sense. Each element of the embodiment and its arrangement, materials, conditions, shape, size, and so on are not necessarily limited to those shown in the examples and can be changed as appropriate. Moreover, the configurations illustrated in the different embodiments can be partly replaced or combined with each other.

For example, the relay apparatus 20 according to the aforementioned embodiments has been explained by showing an example of a separated-type apparatus in which the relay node 22 and the access node 24 are separated from each other; however, the relay apparatus 20 may be an integrated-type apparatus in which the relay node 22 and the access node 24 are integrated with each other. In the case of the separated-type apparatus, a plurality of access nodes may be provided for one relay node.

### INDUSTRIAL APPLICABILITY

The above-described embodiments have described the systems which adopt LTE as a communications standard for mobile communication. However, the present invention can be applied to other systems having the same object as that of the present invention. Specifically speaking, when an attempt is made to execute the beamforming when the access radio is active at the relay apparatus for relaying communication between the donor base station and the terminal device, the present invention can be applied as long as the relevant system has a problem of degradation of communication quality at other base stations located in directions other than a direction of a main beam as a result of formation of small beams in the directions other than the direction of the main beam. The operation and effect capable of precisely executing the beamforming from the relay apparatus to the donor base station can be expected by applying the relay method according to the present invention.

### REFERENCE SIGNS LIST

10 terminal device

20 relay apparatus

22 relay node

24 access node

30 donor base station

100 radio network

1. A relay apparatus for relaying communication between a terminal device and a donor base station,
the relay apparatus comprising:
an amplitude and phase measurement unit that measures an amplitude and phase of radio communication from surrounding base stations including the donor base station to the relay apparatus;
a beam adjuster that makes adjustment for beamforming by adjusting a combination of a plurality of antennas used at the relay apparatus on the basis of the measured amplitude and phase; and
a base station judgment unit that judges the surrounding base stations,
wherein the adjustment for the beamforming is made so that a relatively strong beam is directed towards the donor base station and a relatively weak beam is directed towards the base stations other than the donor base station.

2. The relay apparatus according to claim 1,
wherein when any one of the surrounding base stations fulfills a specified condition, the adjustment for the beamforming is made so that selecting the base station, which fulfills the specified condition, as the donor base station is prohibited and a beam of relatively small field intensity is directed towards the base station which fulfills the specified condition.

3. A relay method for a relay apparatus, comprising:
a step of measuring an amplitude and phase of radio communication from surrounding base stations including a donor base station to the relay apparatus;
a beam adjustment step of making adjustment for beamforming for radio communication from the relay apparatus to the donor base station by adjusting a combination of a plurality of antennas used at the relay apparatus on the basis of the measured amplitude and phase; and
a step of judging the surrounding base stations,
wherein the adjustment for the beamforming is made so that a relatively strong beam is directed towards the donor base station and a relatively weak beam is directed towards the base stations other than the donor base station.
